(19) United States
(12) Patent Application Publication
(10) Pub. No.: US 2008/0094650 A1
(43) Pub. Date: Apr. 24, 2008

(54) PRINT PROCESSING APPARATUS AND METHOD OF CONTROLLING PRINT PROCESSING APPARATUS

(75) Inventor: Takeshi Suzuki, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/853,689

(22) Filed: Sep. 11, 2007

(30) Foreign Application Priority Data
Oct. 20, 2006 (JP) 2006-285827
Jun. 19, 2007 (JP) 2007-161951

(51) Int. Cl. G06F 15/00

(52) U.S. Cl. 358/1.12

(57) ABSTRACT

A print processing apparatus holds in advance information of media sizes and media types of media held in a plurality of feeding trays. Upon receiving print setting information for executing printing, the print processing apparatus checks whether a setting value of at least one of media size and media type is a value for delegating print setting to the print processing apparatus. When the setting value for delegating print setting to the print processing apparatus is included, a feeding tray that is to be used for printing is determined by determining optimal print setting using the print setting information and the information of size and type of media held in the feeding trays.

### BACKGROUND OF THE INVENTION

1. Field of the Invention

The present invention relates to print processing apparatuses and methods of controlling print processing apparatuses. More specifically, the present invention relates to a print processing apparatus and a method of controlling a print processing apparatus with which even when a value for delegating print setting to a print processing apparatus is received by the print processing apparatus regarding setting values in print setting information, an optimal print output can be obtained using information regarding the print processing apparatus.

2. Description of the Related Art

Recently, digital cameras are rapidly becoming commonly available. Although digital cameras had been considered as peripheral devices of personal computers, digital cameras are now increasingly used, even at homes not having personal computers. Accordingly, particularly in recent years, there exists an increasing demand for directly printing data captured by a digital camera using a home printer or the like without using a personal computer.

Data captured by a digital camera is usually stored in a memory card, such as an SD card or a CompactFlash® memory. When a personal computer is available at home, it is possible to transfer captured image data to the personal computer and to print the image data by a recording device, such as a printer.

It is also possible to execute direct printing without using a personal computer by connecting a digital camera to a printer via a USB (Universal Serial Bus) cable. Particularly, a direct printing method called PictBridge® is commonly used.

In PictBridge, for the purpose of printing, a user selects media size, media type, print quality, layout, various types of image correction, etc. using a user interface (UI) of a digital camera. At this time, a value called “standard setting” can be used, with which setting values of media size, media type, etc. are determined according to setting by the printer (i.e., delegated to the printer).

With this value, the user can execute printing without selecting print parameters via the digital camera. Furthermore, even when the UI of the digital camera is poor, conveniently, it suffices to send the value of “standard setting” to the printer without particularly providing options for selection on the UI.

Furthermore, recently, there exists an increasing interest in a printing method called XHTML (eXtensible HyperText Markup Language) printing. In order to execute printing from a personal computer (PC), it has been the case to install a driver for a printer to be used onto the PC.

However, depending on resources of an electronic device and variations among operating systems (OSs) of individual electronic devices, it is difficult to install a printer driver onto an electronic device, such as a cellular phone or a digital television set. This makes it difficult to print data from a cellular phone or a digital television set.

XHTML printing overcomes this problem. In XHTML printing, data compliant with a standard called XHTML, which can be displayed by a browser of a cellular phone or a digital television set, is directly sent to a printer, and the printer parses and prints the XHTML data.

Also in XHTML printing, similarly to the case of PictBridge, for the purpose of printing, a user selects media size, media type, print quality, layout, the number of copies, etc. via the UI of a cellular phone or a digital television set. At this time, specific setting values, such as A4 size or high-quality sheet, are usually used for media size, media type, etc. However, it is also possible to select a setting value called “device-setting”. The value “device-setting” means that values set at a printer should be used. That is, “device-setting” is a value for delegating print setting to a printer, not a specific setting value.

With “device-setting”, the user can execute printing from the cellular phone or the digital television set without selecting print parameters. Furthermore, “device-setting” is convenient for the user since the number of times that the user has to operate small buttons of the cellular phone or a remote controller of the digital television set can be reduced.

Furthermore, techniques have been known for changing how to control printing by a printer on the basis of content of print data transferred to a printer instead of receiving a setting value for delegating setting of print parameters to a printer.

For example, according to Japanese Patent Laid-Open No. H07-089161, it is checked whether a halftone image is included, the image density in each area of a predetermined size is checked, and so forth according to data to be printed. For example, when the data to be printed corresponds to an original text document, stationery sheets, which are relatively inexpensive, are used. When the print data corresponds to an original picture document, special sheets are used. This serves to reduce running cost of printing.

Japanese Patent Laid-Open No. 2004-306324 is directed to exercising control when XHTML data is received by a printer. When parsing the XHTML data, the printer checks whether an image file is included, whether the scaling ratio of the image file is greater than or equal to a predetermined value, and so forth, on a page-by-page basis. Sheets and print mode are changed according to the results so that the data will be printed with more suitable print parameters.

However, the inventors of the present invention note that, depending on the printer used, it is possible that information of sheets set to a feeding tray is not held. In such cases, when a printer receives print data with a value indicating delegation of print setting to the printer, the printer executes printing using values of print setting selected by the user and stored in the printer in advance.

On the other hand, when information of sheets set to a feeding tray is held by the printer, when the printer receives print data with a value indicating delegation of print setting to the printer, the printer determines print setting on the basis of the information of sheets set to the feeding tray.

Furthermore, when the printer has a plurality of feeding trays, usually, the user selects in advance which feeding tray is to be used with priority. That is, even when the printer has a plurality of feeding trays, the printer can determine which feeding tray is to be used.

However, when the printer has a plurality of feeding trays and holds information of sheets set in the individual feeding trays, according to the related art, it is not possible to achieve optimal print setting when a value indicating delegation of print setting to the printer is received regarding either media size or media type.

For example, consider a case where the following setting is registered in a printer.

First feeding tray: “L size” as media size and “photo sheet” as media type”
Second feeding tray: “A4 size” as media size and “stationery sheet” as media type”

### The setting of the feeding tray to be used for printing is the first feeding tray.

### Case 1

Now, a case will be considered with a request with device-setting as media size and device-setting as media type is received.

In this case, since the setting of the feeding tray to be used for printing is the first feeding tray, a sheet is fed from the first feeding tray, and printing is executed according to the setting of “L size” and “photo sheet”, which is the setting associated with the first feeding tray.

### Case 2

Now, a case will be considered with a request with A4 size as media size and device-setting as media type is received.

In this case, since the setting of the feeding tray to be used for printing is the first feeding tray, a sheet is fed from the first feeding tray, and printing is executed according to the setting of “L size” and “photo sheet”, which is the setting associated with the first feeding tray.

In Case 1, since the setting of both media size and media type is delegated to the printer, it is not wrong for the printer to select any media size and media type. In contrast, in Case 2, a print request with the setting of “A4 size” and “delegation to printer” is received. In this case, since the setting of the feeding tray to be used for printing is the first feeding tray, the printer selects photo sheet as the media type. Furthermore, the printer selects A4 size as the media size, so that printer data of the A4 size is generated. However, the sheets held in the first feeding tray are sheets of the L size, so that the print data of the A4 size is printed only partially.

As described above, when print setting includes delegation to a printer and print data with the print setting is sent to the printer, in some cases, it is not possible to obtain print data desired by the user.

### SUMMARY OF THE INVENTION

The present invention provides a print processing apparatus and a method of controlling a print processing apparatus such that even when a value for delegating print setting to a print processing apparatus is received by the print processing apparatus regarding at least one of setting values of media size and media type in print setting information, an optimal print output can be obtained using information regarding media held in feeding units.

According to a first aspect of the present invention, there is provided a print processing apparatus including a plurality of feeding units; a memory unit configured to store media information regarding media individually held by the plurality of feeding units; a holding unit configured to hold definition information in advance, the definition information defining combinations of media size and media type available in the print processing apparatus; a receiving unit configured to receive print setting information from an external apparatus that requests printing, the print setting information including setting values of media size and media type; and a processing unit configured to execute processing for determining a feeding unit to be used for printing among the plurality of feeding units on the basis of the print setting information, the media information, and the definition information; wherein when at least one of the setting values of media size and media type in the print setting information is a delegated setting value for requesting that print setting be determined by the print processing apparatus, the processing unit replaces the delegated setting value with the media information of one of the plurality of feeding units, and determines with reference to the definition information whether it is allowed to execute printing according to the print setting information which replaces the delegated setting value with the media information of one of the plurality of feeding units.

According to a second aspect of the present invention, there is provided a method of controlling a print processing apparatus having a plurality of feeding units, the method comprising the steps of storing media information in a memory unit, the media information regarding media individually held by the plurality of feeding units; reading definition information defining combinations of media size and media type available in the print processing apparatus; receiving print setting information from an external apparatus that requests printing, the print setting information including setting values of media size and media type; and executing processing for determining a feeding unit to be used for printing among the plurality of feeding units on the basis of the print setting information, the media information, and the definition information; wherein, in the processing step, when at least one of the setting values of media size and media type in the print setting information is a delegated setting value for requesting that print setting be determined by the print processing apparatus, the delegated setting value is replaced with the media information of one of the plurality of feeding units, and it is determined with reference to the definition information whether it is allowed to execute printing according to the print setting information which replaces the delegated setting value with the media information of one of the plurality of feeding units.

Further features of the present invention will become apparent from the following description of exemplary embodiments with reference to the attached drawings.

### BRIEF DESCRIPTION OF THE DRAWINGS

FIG. 1 is a diagram showing a print processing system including a print processing apparatus according to an embodiment of the present invention.

FIG. 2 is a diagram schematically showing the print processing apparatus according to the embodiment.

FIG. 3 is a block diagram schematically showing a multifunction machine in the embodiment.

FIG. 4 is an illustration showing an example of an operation and display unit provided in the multifunction machine.

FIG. 5 is a block diagram schematically showing the configuration of a LAN unit provided in the print processing apparatus.

FIG. 6 is a diagram showing a sequence of execution of XHTML printing in the embodiment.

FIG. 7 is a diagram showing an example of a part of an XML file sent by the print processing apparatus.

FIG. 8 is a flowchart showing a procedure of registering media information for each feeding tray in a multifunction machine having a plurality of feeding trays.

FIG. 9 is a diagram schematically showing first sheet definition information defining media sizes, media types, and print qualities.

FIG. 10 is a flowchart showing an operation of checking parameters (MediaSize, MediaType, and PrintQuality) of a CreateJob command received from a digital television set in the embodiment.

FIG. 11 is a flowchart showing an operation of checking parameters (MediaSize, MediaType, and PrintQuality) of a CreateJob command received from a digital television set in the embodiment.

FIG. 12 is a diagram schematically showing second media definition information defining optimal print qualities for combinations of media size and media type.

### DESCRIPTION OF THE EMBODIMENTS

Preferred embodiments of the present invention will now be described in detail in accordance with the accompanying drawings.

First, an overview of a system for executing XHTML printing will be described.

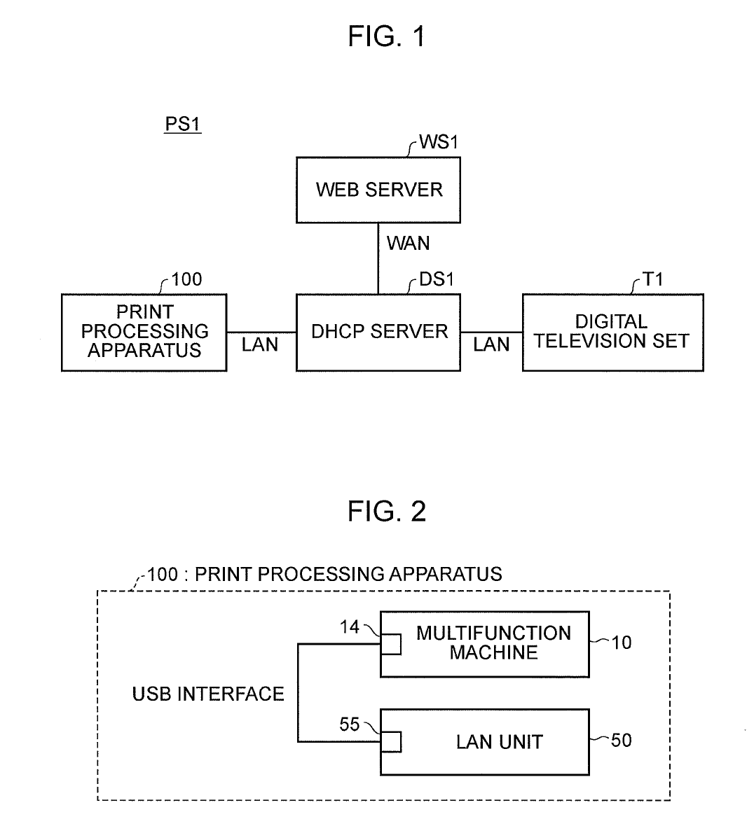

FIG. 1 is a diagram showing a print processing system PS1 including a print processing apparatus 100 according to an embodiment of the present invention. The print processing system PS1 includes the print processing apparatus 100, a DHCP server DS1, a Web server WS1, and a digital television set T1 as an external apparatus. The print processing apparatus 100 and the digital television set T1 support XHTML printing.

The print processing apparatus 100 and the digital television set T1 are connected to each other via the DHCP server DS1 and a local area network (LAN) so that communications can be carried out with each other. Furthermore, the DHCP server DS1 is connected to the Web server WS1 via a wide area network (WAN) so that communications can be carried out with the Web server WS1. Alternatively, the DHCP server DS1 may be connected to the Web server WS1 via a LAN.

Referring additionally to FIG. 2, FIG. 2 is a schematic diagram showing the print processing apparatus 100. The print processing apparatus 100 includes a multifunction machine 10 and a LAN unit 50. The multifunction machine 10 has a plurality of feeding trays (feeding units).

Furthermore, a USB function controller 14 of the multifunction machine 10 is connected via a USB interface to a USB host controller 55 of the LAN unit 50, which functions as a receiving unit. Thus, the print processing apparatus 100 can be connected to a network.

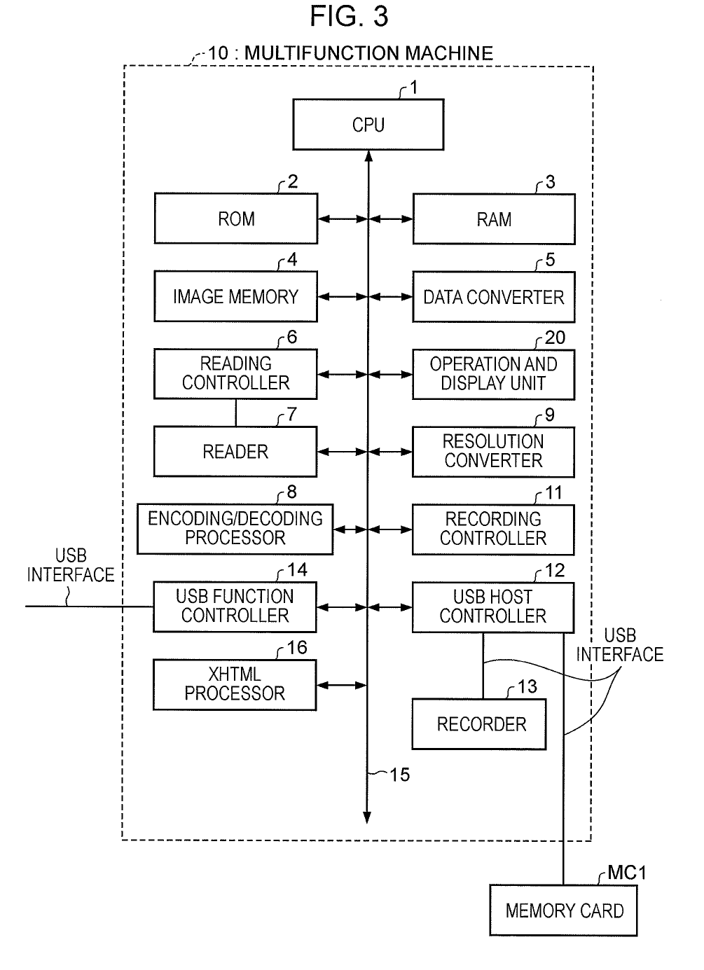

Referring additionally to FIG. 3, FIG. 3 is a block diagram schematically showing the configuration of the multifunction machine 10 in the print processing apparatus 100.

A central processing unit (CPU) 1 functions as a system controller that controls the multifunction machine 10 as a whole.

A read-only memory (ROM) 2 stores fixed data, such as control programs executed by the CPU 1, data tables, and an embedded operating system (OS) program. In this embodiment, the control programs stored in the ROM 2 exercises software execution control under the control of the embedded OS stored in the ROM 2, such as scheduling, task switching, and interrupt handling. The information stored in the ROM 2 is loaded into a random access memory (RAM) 3 when the information is used.

The RAM 3 functions as a storage unit. The RAM 3 is implemented by a static random access memory (SRAM) or the like, which requires power supply for backup, and data is maintained by a primary battery (not shown) for data backup. Information of media that are set to the plurality of feeding trays (media size, media type, etc.), which will be described later, is stored in the RAM 3. Furthermore, data that should not be deleted, such as program control variables, are also stored in the RAM 3. Furthermore, a memory area for storing setting values registered by an operator, management data of the multifunction machine 10, and so forth is provided in the RAM 3.

An image memory 4 is implemented by a dynamic random access memory (DRAM) or the like, and it stores image data. Furthermore, a partial area of the image memory 4 is allocated as a work area for execution of software processing.

A data converter 5 executes conversion of image data, such as parsing of page description language (PDL) data and computer graphics (CG) rendering of character data.

A reading controller 6 controls a contact image sensor (CIS) or a charge coupled device (CCD) image sensor provided in a reader 7 to optically read an original document. The original document that has been read is converted into electric image data to obtain image signals. The image signals undergo various types of image processing in an image processing controller (not shown), such as binarization or halftoning, whereby high-definition image data is output. In this embodiment, a sheet-reading control method, in which an original document is read while moving the original document, and a book-reading control method, in which an original document fixed on an original plate is scanned, are supported.

A resolution converter 9 controls resolution conversion, such as conversion between millimeter-based image data and inch-based image data. The resolution converter 9 is also capable of enlarging or reducing image data.

An encoding/decoding processor 8 executes encoding and decoding of image data (non-compression, MH, MR, MMR, JBIG, JPEG, etc.) handled by the multifunction machine 10, and also enlarges or reduces image data.

A recording controller 11 converts image data that is to be printed into high-definition image data by executing various types of image processing in an image processing controller (not shown), such as smoothing, recording level correction, or color correction. The image data is output to a USB host controller 12. Furthermore, the recording controller 11 controls the USB host controller 12 to periodically obtain status information data of a recorder 13.

The USB host controller 12 is a controller for carrying out communications according to a protocol defined by the USB communication standard. The USB communication standard is a standard for carrying out high-speed bilateral data communications, and it is possible to connect a plurality of hubs or functions (slaves) to a single host (master). The USB host controller 12 acts as a host in USB communications.

The recorder 13 is a recording device controlled by a dedicated CPU (not shown), such as a laser beam printer or an ink jet printer. The recorder 13 prints color image data or monochrome image data received via a USB interface onto a print sheet (print medium). Furthermore, the recorder 13 carries out communications with the USB host controller 12 according to a protocol defined by the USB communication standard. Particularly, the recorder 13 acts as a function in the USB communication standard. In this embodiment, USB communications for recording are carried out via a one-to-one connection.

The USB function controller 14 controls communications carried out via a USB interface according to a protocol defined in the USB communication standard. The USB function controller 14 data generated with a USB function controlling task executed by the CPU 1 into packets, and sends the USB packets to the USB host controller 55 of the LAN unit 50. Furthermore, conversely, the USB function controller 14 converts USB packets received from the USB host controller 55 into data, and sends the data to the CPU 1.

A memory card MC1 is a data storage medium, and it can be connected to the multifunction machine 10. In this embodiment, the memory card MC1 is connected to the multifunction machine 10 via a USB interface. However, the connection may be based on other protocols. Data in the memory card MC1 can be accessed via the USB host controller 12.

An XHTML processor 16 sends commands to and receives commands from the digital television set T1. At this time, when “device-setting” is received as a print setting value, an optimal print setting is determined using information of a plurality of feeding trays of the multifunction machine 10. The “device-setting” is a print setting value indicating, for example, “print setting is to be delegated to the print processing apparatus 100”, as described earlier. Regarding the present invention, a print setting value indicating that specific print setting is to be delegated and requested to a print processing apparatus, such as device-setting in this embodiment, is defined as a “delegated setting value”.

Furthermore, the XHTML processor 16 parses an XHTML file received from the USB function controller 14 or an XHTML file stored in a memory card to generate print data.

When it is found that an image file or a stylesheet file is needed as a result of parsing the XHTML file, the XHTML processor 16 reports information indicating the situation to the LAN unit 50 via the USB function controller 14. Then, the LAN unit 50 receives the image file or the stylesheet file obtained from the Web server WS1, and generates print data using the file. Then, the print data that has been generated is printed using the recording controller 11, the USB host controller 12, and the recorder 13.

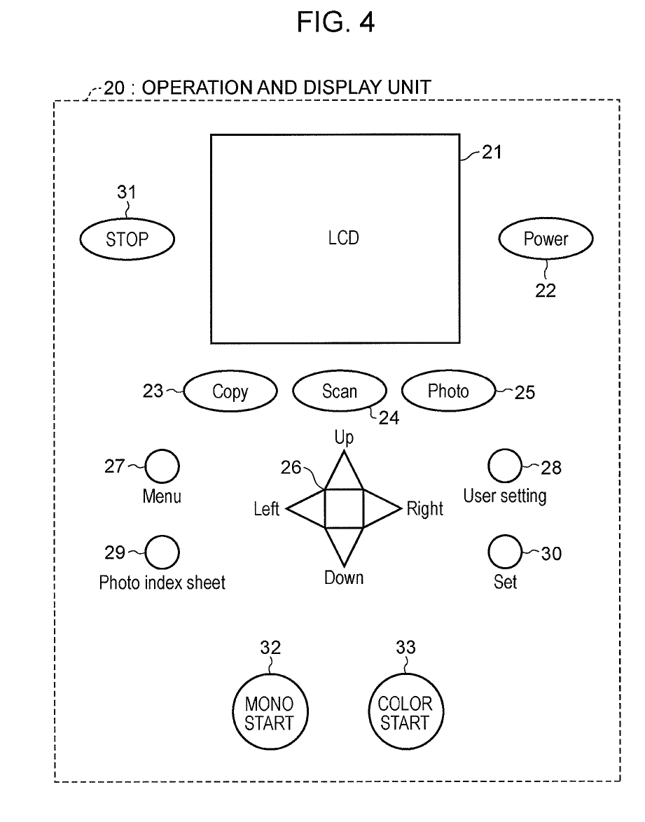

An operation and display unit 20 includes an operation unit having various keys, and a display unit having light-emitting diode (LED) lamps and a liquid crystal display (LCD). The display unit allows various operations by an operator, and displays an operation status of the multifunction machine 10 and so forth. The operation and display unit 20 will be described later in detail with reference to FIG. 4.

The components 1 to 6, 8 to 12, 14, 16, and 20 are connected to each other via a CPU bus 15 managed by the CPU 1.

Referring additionally to FIG. 4, FIG. 4 is an illustration showing an example of the operation and display unit 20 provided in the multifunction machine 10. An LCD 21 is a display for displaying messages, operation prompts, and various types of information. A power key 22 is used to power on or power off the multifunction machine 10. A copy mode key 23 is a key for causing the multifunction machine 10 to be ready for executing copying. The multifunction machine 10 can be set to a copy mode by pressing the copy mode key 23.

A scan mode key 24 is a key for causing the multifunction machine 10 to be ready for executing scanning. The multifunction machine 10 can be set to a scan mode by pressing the scan mode key 24. A photo mode key 25 is a key for causing the multifunction machine 10 to be ready for direct printing of a digital picture from a memory card MC1 or a digital camera (not shown) connected to the USB host controller 12. The multifunction machine 10 can be set to a photo mode by pressing the photo mode key 25.

Up/down/left/right keys 26 are used when a user selects an option from a plurality of options of a menu, user setting, or the like. A menu key 27 is a key for displaying items for setting setting values at the time of copying, direct printing from a card, or the like. Setting items for execution can be displayed on the LCD 21 by pressing the menu key 27, a setting item can be selected using the up/down/left/right keys 26, and a value can be set using a set key 30.

A photo index sheet key 29 is a key for displaying a screen for printing on a photo index sheet or reading from a photo index sheet. The set key 30 is a key for determining a selected item. A stop key 31 is a key for stopping a facsimile sending or receiving operation, a copying operation, or other operations. A monochrome start key 32 is a key for starting monochrome copying, monochrome scanning, or the like. A color start key 33 is a key for starting color copying, color push scanning, color picture printing, or the like.

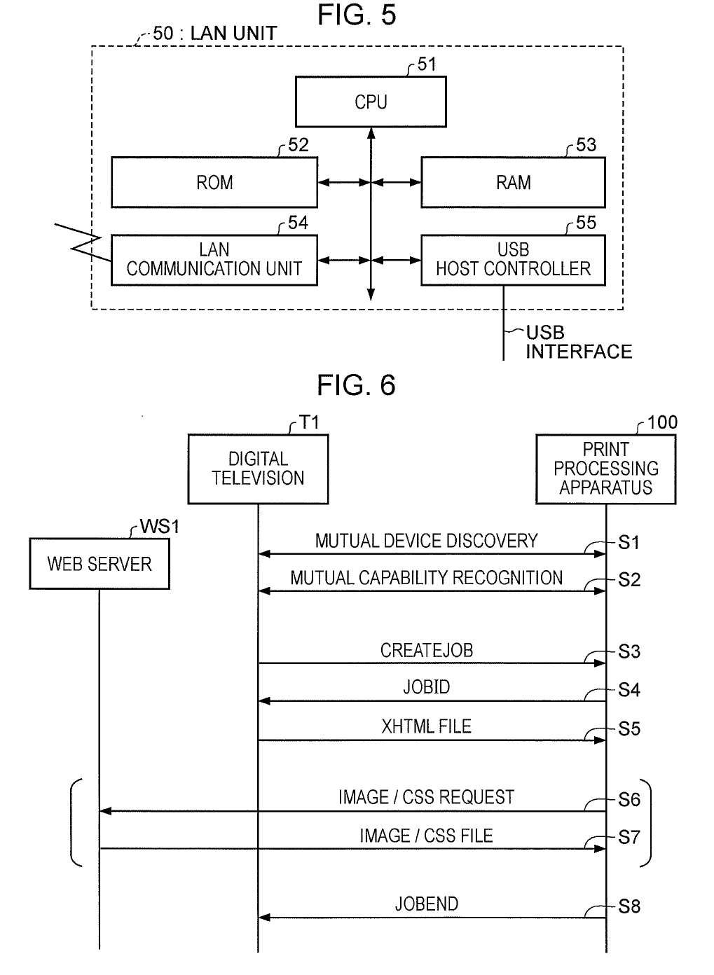

FIG. 5 is a block diagram schematically showing the configuration of the LAN unit 50 provided in the print processing apparatus 100. A CPU 51 controls the overall operation of the LAN unit 50 via a system bus according to programs stored in a ROM 52 or a RAM 53. The ROM 52 stores control programs for the CPU 51, etc. The RAM 53 stores programs and image data.

A LAN communication unit 54 carries out communications via a LAN, and can be implemented by a LAN control chip. LAN control chips are available from various manufacturers. Furthermore, in order to skip authentication for communications, a PCMCIA card LAN adapter may be connected to a CPU bus via a PCMCIA card controller (not shown). PCMCIA card LAN adapters are also available from various manufacturers.

The USB host controller 55 controls communications carried out via a USB interface. The USB host controller 55 converts data supplied from the CPU 51 into packets and sends the USB packets to the USB function controller 14 of the multifunction machine 10 according to the USB communication standard. Furthermore, conversely, the USB host controller 55 converts USB packets supplied from the USB function controller 14 of the multifunction machine 10 into data and sends the data to the CPU 51. The communications can be controlled according to well known methods.

Referring additionally to FIG. 6, FIG. 6 is a sequence diagram showing a procedure for executing XHTML printing. First, in steps S1 and S2, the print processing apparatus 100 and the digital television set T1 discover mutual devices and recognize device capabilities according to SSDP of UPnP. UPnP is an abbreviation of Universal Plug and Play, and SSDP is an abbreviation of the Simple Service Discovery Protocol. At this time, on the basis of a request from the digital television set T1, the print processing apparatus 100 sends an XML file describing capabilities of the print processing apparatus 100 to the digital television set T1.

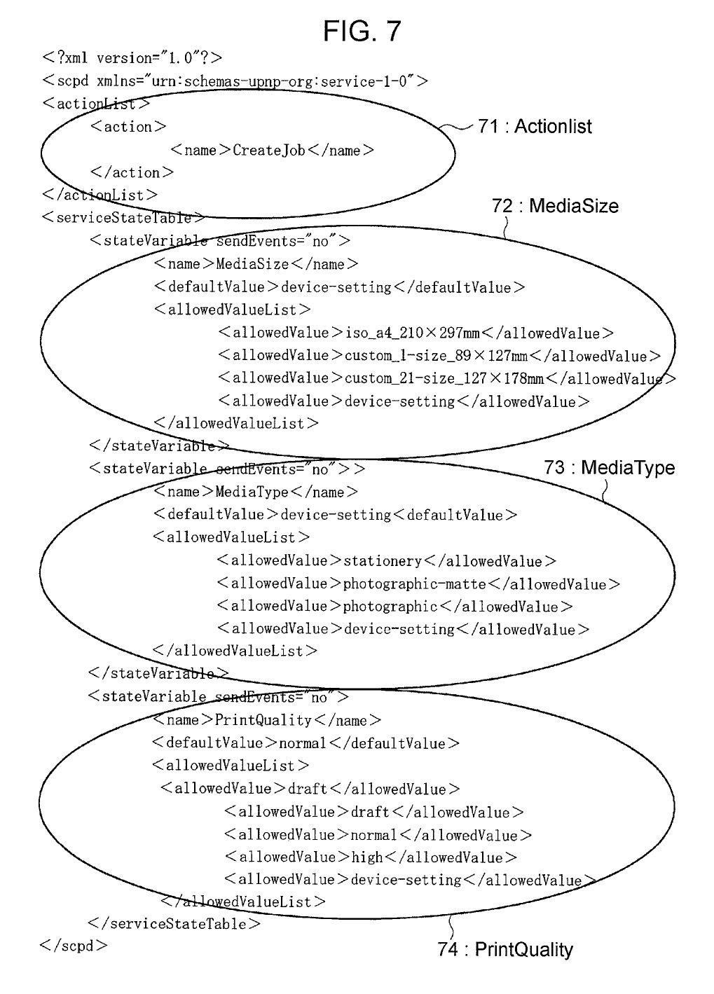

Referring additionally to FIG. 7, FIG. 7 is a diagram showing an example of a part of the XML file sent by the print processing apparatus 100. Actionlist 71 describes commands that can be used between the print processing apparatus 100 and the digital television set T1 and supported by the print processing apparatus 100. CreateJob is a command for executing printing from the digital television set T1. Although not shown, actually, an OUT parameter and an IN parameter used with the CreateJob command are also described. Furthermore, although not shown, in addition to CreateJob, other commands, such as CancelJob for canceling a job, GetPrinterAttributes for getting printer attributes, are also described.

Elements 72 to 74 shown in FIG. 7 are detailed descriptions of print setting parameters used with the commands in Actionlist 71. MediaSize 72 indicates that the media sizes supported by the print processing apparatus 100 are A4, L, 2L, and device-setting. MediaType 73 indicates that the media types supported by the print processing apparatus 100 are stationery sheet, matte sheet, photo sheet, and device-setting. PrintQuality 74 indicates that print qualities supported by the print processing apparatus 100 are draft, normal, high, and device-setting.

Then, in step S3, the user selects a subject of printing from the digital television set T1, and requests printing. The user sets various parameters, such as MediaSize, MediaType, and PrintQuality, on the screen of the digital television set T1 using a remote controller of the digital television set T1.

The print processing apparatus 100 receives a CreateJob command from the digital television set T1 at which a print request is input by the user. Upon receiving the CreateJob command, the print processing apparatus 100 checks parameter values and the status of the print processing apparatus 100. The checking of the parameter values will be described later.

When the print processing apparatus 100 is ready for printing, in step S4, the print processing apparatus 100 sends a value called JOBID to the digital television set T1. When the print processing apparatus 100 is not ready for printing, the print processing apparatus 100 reports the situation to the digital television set T1, and exits the procedure without executing printing.

Then, in step S5, the digital television set T1 sends an XHTML file selected by the user as a file to be printed to the print processing apparatus 100. Upon receiving the XHTML file, the print processing apparatus 100 parses the XHTML file. When it is found as a result of the parsing that an image file or a stylesheet file is needed, in step S6, the print processing apparatus 100 sends a request for the image file or the stylesheet file to the Web server WS1. In step S7, the Web server WS1 sends the requested file to the print processing apparatus 100. Finally, when printing of the XHTML file is finished, in step S8, the print processing apparatus 100 notifies the digital television set T1 of the completion of the job.

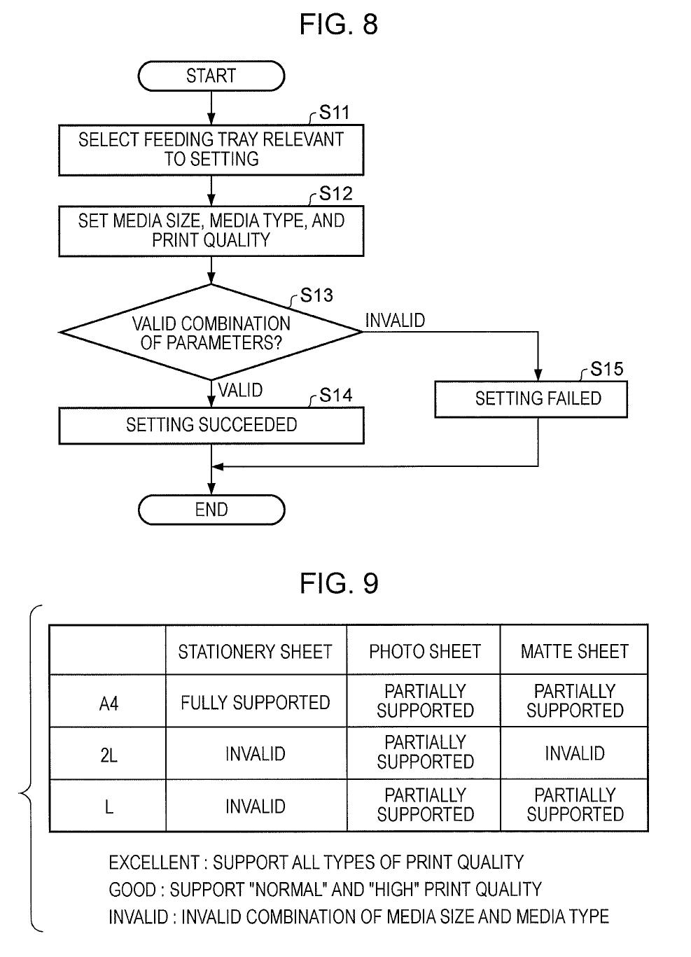

Next, a procedure for registering media information for each feeding tray in the multifunction machine 10 having a plurality of feeding trays will be described with reference to a flowchart shown in FIG. 8. In the following examples, the multifunction machine 10 in this exemplary embodiment has two feeding trays, namely, a large feeding tray for accommodating large-size media and a small feeding tray for accommodating small-size media. However, the present invention is not limited by the types of feeding trays. For example, the multifunction machine 10 may have two large feeding trays. Furthermore, the number of feeding trays is not limited to two. The present invention is applicable to cases where the number of feeding trays is two or greater.

First, when a user setting key 28 is pressed by the user, the CPU 1 displays on the LCD 21 a screen for registering setting values that are to be set to the multifunction machine 10. Among items that are displayed, the user selects media registration (not shown) using the up/down/left/right keys 26 and the set key 30.

Then, in step S11, in response to an operation by the user, a feeding tray for which the user wishes to define setting is selected from a list of feeding trays displayed on the LCD 21. As stated previously, the multifunction machine 10 has two feeding trays with different sizes, namely, a small feeding tray and a large feeding tray. The large feeding tray allows setting of two media sizes, namely, A4 and 2L, and the small feeding tray allows setting of only one media size, namely, L.

Referring additionally to FIG. 9, FIG. 9 is a diagram schematically showing first media definition information defining supported combinations of media size and media type. In this embodiment, the first media definition information is provided in the form of a table. This information is stored in a storage unit, for example, the ROM 2. According to the first media definition information, for example, with the A4 media size, media types of A4 stationery sheet, A4 photo sheet, and A4 matte sheet are all supported. Furthermore, it is defined that A4 stationary sheet can be used with all types of print quality.

In step S12, an operation by the user for selecting a media size, a media type, and a print quality using the up/down/left/right keys 26 and the set key 30 is accepted. When the large feeding tray has been selected in step S11, it is possible to set either A4 or 2L as the media size.

In step S13, the CPU 1 checks whether the combination of the parameters set in step S12 is valid. This checking is executed on the basis of the first media definition information. When the combination of the parameters is valid, in step S14, the CPU 1 notifies the user of the success of setting via the LCD 21, and the procedure for setting media information is exited. The media information that has been set is stored in the RAM 3.

On the other hand, when the combination of the parameters is invalid, in step S15, the CPU 1 notifies the user of the failure of setting via the LCD 21, and the procedure for setting media information is exited.

In the example shown in FIG. 8, media information of each feeding tray is registered via the operation and display unit 20. According to the present invention, alternatively, the print processing apparatus 100 may have a function of a Web server so that media information of each feeding tray can be registered from a Web client of a personal computer (not shown) connected to the digital television set T1 and the print processing apparatus 100 via a LAN or a WAN.

Furthermore, if it is possible to automatically recognize a size and a type of media held in a feeding tray and to obtain corresponding information, it is possible to use this information.

Next, an operation for checking parameters (MediaSize, MediaType, and PrintQuality) of the CreateJob command received from the digital television set T1 (step S3) will be described in detail.

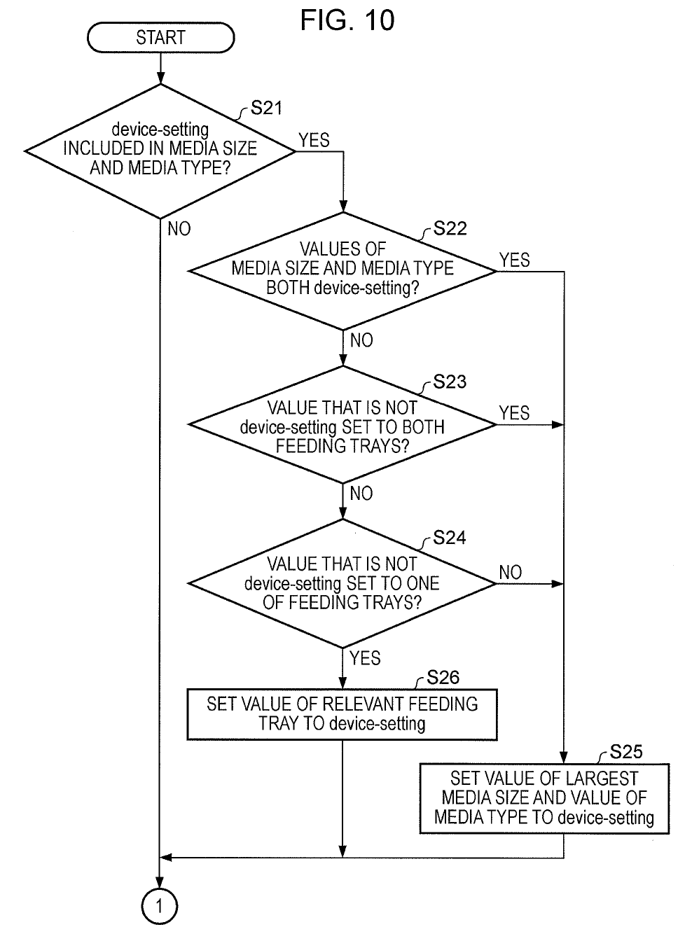

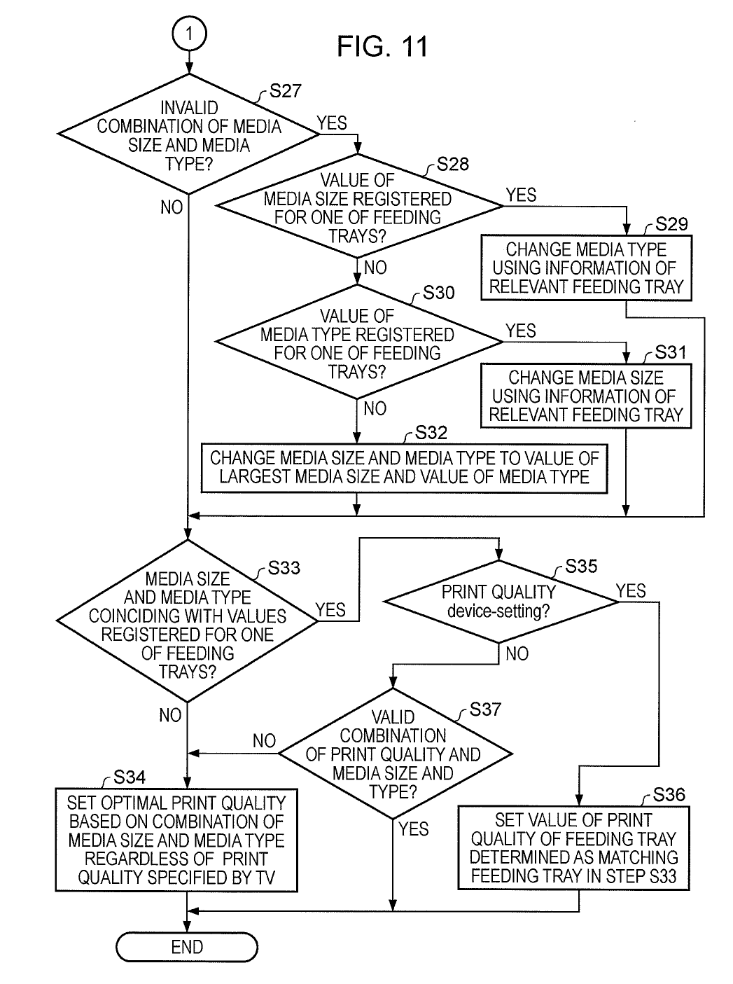

Referring now additionally to FIGS. 10 and 11, FIGS. 10 and 11 are flowcharts of the operation executed by the print processing apparatus 100 for checking parameters (MediaSize, MediaType, and PrintQuality) of the CreateJob command received from the digital television set T1 (step S3).

Upon receiving the CreateJob command, the multifunction machine 10 determines an optimal print setting using the parameters received by the XHTML processor 16 and the media information of each tray stored in the RAM 3.

First, in step S21, the XHTML processor 16 checks whether device-setting is included in the setting information indicating media size and media type, received from the digital television set T1. When device-setting is not included, the procedure proceeds to step S27. When device-setting is included, steps S22 to S26 are executed to replace device-setting with specific setting values.

In step S22, the XHTML processor 16 checks whether the values of both media size and media type are device-setting. When the values are both device-setting, it is allowed to use information of any feeding tray set in the multifunction machine 10. However, in order to obtain an expected print result more reliably, it is desired to use a sheet of a larger media size. Thus, in step S25, the XHTML processor 16 replaces device-setting of the values of both media size and media type with the values of media size and media type of a largest sheet among sheets held in the plurality of feeding trays.

When it is determined in step S22 by the XHTML processor 16 that the values of media size and media type are not both device-setting, the procedure proceeds to step S23. Then, in step S23, the XHTML processor 16 determines whether the value of setting information that is not device-setting is registered for both the large feeding tray and the small feeding tray.

That is, it is possible to determine that either feeding tray can be used if the value of setting information that is not device-setting is registered for both the large feeding tray and the small feeding tray. However, in order to obtain an expected print result more reliably, it is desired to use a sheet of a larger media size. Thus, after processing from step S23 to step S25, the XHTML processor 16 replaces device-setting with the value of media size or media type of a largest sheet among sheets held in the plurality of feeding trays. Whether to use the value of media size or media type is determined correspondingly to whether the value of media size or media type in the setting information is device-setting.

When it is determined in step S23 that the value of setting information that is not device-setting is not registered for either the large feeding tray or the small feeding tray, the XHTML processor 16 executes processing similar to the processing executed in step S24. In step S24, the XHTML processor 16 checks whether the value of setting information that is not device-setting is registered for either the large feeding tray or the small feeding tray. When the value of setting information is registered for either the large feeding tray or the small feeding tray, in step S26, the XHTML processor 16 replaces device-setting with the registered information of the feeding tray. When the value of setting information is not registered for either the large feeding tray or the small feeding tray, information of any feeding tray set in the multifunction machine 10 can be used. However, it is desired to use a sheet of a larger size for printing. Thus, in step S25, the XHTML processor 16 replaces device-setting with the value of media size or media type of a largest sheet among sheets held in the plurality of feeding trays.

Then, in step S27, the XHTML processor 16 checks whether the combination of media size and media type determined through the processing flow described above is valid according to the first media definition information.

For example, when the media size is 2L, in step S27, it is determined that the combination is valid if the sheet type is photo sheet. On the other hand, it is determined that the combination is invalid if the media type is matte sheet, since the combination does not accord with the first media definition information shown in FIG. 9.

When the combination of media size and media type is valid, the procedure proceeds to step S33. When the combination of media size and media type is invalid, steps S28 to S32 are executed to replace the combination of media size and media type with a valid combination.

First, in step S28, the XHTML processor 16 checks whether the value of media size in the setting information of the CreateJob command is a value registered for at least one of the large feeding tray and the small feeding tray. When it is determined that the value is registered for at least one of the large feeding tray and the small feeding tray, the procedure proceeds to step S29. In step S29, the XHTML processor 16 changes the value of media type in the setting information of the CreateJob command using the information of media type registered for the feeding tray with the matching media size.

When the value of media size is not registered for either the large feeding tray or the small feeding tray, the procedure proceeds to step S30. In step S30, the XHTML processor 16 checks whether the value of media type in the setting information of the CreateJob command is a value registered for at least one of the large feeding tray and the small feeding tray. When it is determined that the value is registered for at least one of the large feeding tray and the small feeding tray, the procedure proceeds to step S31. In step S31, the XHTML processor 16 changes the value of media size in the setting information of the CreateJob command using the information of media size registered for the feeding tray with the matching media type.

When the value of media type in the setting information of the CreateJob command is not registered for either feeding tray, neither the media size nor the media type matches that of any feeding tray. In this case, although it is possible to use information of any feeding tray set in the multifunction machine 10, it is desired to use a sheet of a larger media size. Thus, in step S32, the XHTML processor 16 replaces the values of both media size and media type with the values of media size and media type of a largest sheet among sheets held in the plurality of feeding trays.

In the procedure described above, it is desired to use a sheet of a larger media size for printing in order to minimize the risk of failure to print print data within a sheet, i.e., in order to minimize the risk of partial loss of print data.

Finally, in steps S33 to S37, the XHTML processor 16 checks the value of print quality in the setting information of the CreateJob command received from the digital television set T1.

First, in step S33, the XHTML processor 16 checks whether the combination of media size and media type determined through the procedure described above matches the feeding-tray information registered in the multifunction machine 10.

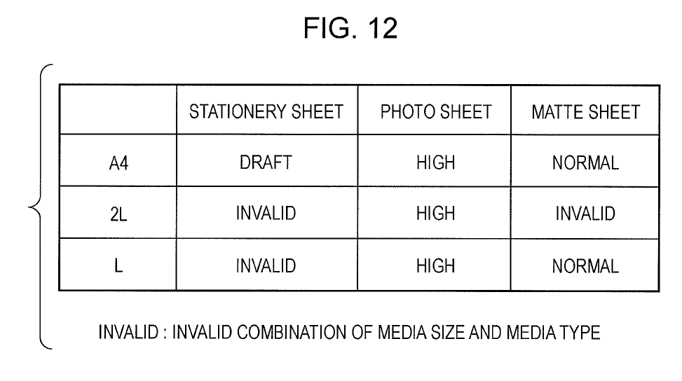

Referring additionally to FIG. 12, FIG. 12 is a schematic diagram showing second media definition information defining optimal print qualities for combinations of media size and media type of sheets that can be held in the feeding trays of the multifunction machine 10. This information is also stored in the ROM 2, similarly to the first media definition information.

When the setting information of media size and media type determined through the procedure described above does not match the feeding-tray information, the procedure proceeds to step S34. In step S34, regardless of the print quality received from the digital television set T1, the XHTML processor 16 sets an optimal print quality compatible with the combination of media size and media type according to the second media definition information shown in FIG. 12. For example, when the setting information of print data indicates 2L as the media size and photo sheet as the media type, “high” is set as the print quality according to the second media definition information.

On the other hand, when the setting information of media size and media type that have been determined matches the feeding-tray information, the procedure proceeds to step S35. In step S35, the XHTML processor 16 checks whether the print quality of print data received from the digital television set T1 is device-setting. When the print quality of the print data is device-setting, in step S36, the XHTML processor 16 replaces device-setting with the print quality registered for the feeding tray with the matching media size and media type.

When it is determined in step S35 by the XHTML processor 16 that the print quality received from the digital television set T1 is not device-setting, the procedure proceeds to step S37. In step S37, it is checked whether the combination of the media size and media type determined through the procedure described above and the print quality set for the print data is valid according to the first media definition information. When it is determined that the combination is valid, the print quality received from the digital television set T1 is used as it is. When the combination is invalid, in step S34, regardless of the print quality received from the digital television set T1, the XHTML processor 16 determines an optimal print quality according to the second media definition information on the basis of the combination of media size and media type.

Through the procedure described above, the XHTML processor 16 determines optimal values of media size, media type, and print quality. That is, a feeding tray corresponding to these setting values that have been determined is determined as a tray that is to be used for printing the print data.

Next, the flowcharts shown in FIGS. 10 and 11 and described above will be described in the context of specific examples.

For the purpose of the following example, it is presumed that the following setting has been registered for the feeding trays of the multifunction machine 10.

Small feeding tray: Media size “L”, media type “photo”, print quality “high”
Large feeding tray: Media size “A4”, media type “stationery”, print quality “draft”

### Case 1

First, a case will be considered where a CreateJob command with print setting information indicating “L size” as media size, “device-setting” as media type, and “device-setting” as print quality is received.

First, in step S21, the XHTML processor 16 determines that device-setting is included in the media type, so that the procedure proceeds to step S22. In step S22, the XHTML processor 16 determines that the media size is not device-setting, so that the procedure proceeds to step S23.

In this case, since the setting information that is not device-setting, i.e., the setting information of media size, is a value indicating L size. Thus, in step S23, the XHTML processor 16 checks whether this value (L size) is registered for both feeding trays.

As mentioned above, L size is registered as the media size for the small feeding tray. On the other hand, A4 size is registered as the media size for the large feeding tray. That is, L size is registered for only one of the feeding trays. Thus, the procedure proceeds to step S24.

In step S24, the XHTML processor 16 checks whether the setting that is not device-setting is registered for either the large feeding tray or the small feeding tray. In this case, the setting that is not device-setting (i.e., media size) matches that of the small feeding tray, so that the procedure proceeds to step S26.

In step S26, the XHTML processor 16 replaces the setting information of media type, which has been device-setting, with “photo”, which is the media type registered for the small feeding tray.

Then, in step S27, the XHTML processor 16 checks the combination of media size and media type. Through the procedure up to step S26, L size is set as the media size and photo sheet is set as the media type in the print setting information of the print data. Thus, it is checked whether this information matches the first media definition information. With reference to the first media definition information defining combinations as shown in FIG. 9, it is understood that the media size of L is associated with the media type of photo sheet or matte sheet. That is, the setting information of the print data matches the first media definition information. Thus, the procedure proceeds to step S33.

In step S33, the XHTML processor 16 checks whether the combination of L size and photo sheet, determined through the procedure described above, matches information of either one of the two feeding trays, registered in the multifunction machine 10. In this case, the combination of L size and photo sheet coincides with the values registered for the small feeding tray. Thus, the procedure proceeds to step S35, in which the XHTML processor 16 checks whether the print quality in the print setting of the print data is device-setting. In this case, the print quality is device-setting, so that the procedure proceeds to step S36. In step S36, the XHTML processor 16 replaces the value of print quality in the print setting with “high”, which is the print quality registered for the small feeding tray.

Through the procedure described above, finally, the print setting of the print data is determined as “L size” as media size, “photo sheet” as media type, and “high” as print quality. That is, the small feeding tray, which corresponds to this print setting, is determined as a feeding tray that is to be used for printing the print data.

Next, specific description will be given in the context of another case.

### Case 2

Now, a case will be considered where a CreateJob command with print setting information indicating “2L size” as media size, “device-setting” as media type, and “normal” as print quality is received.

First, in step S21, the XHTML processor 16 determines that device-setting is included in media type, so that the procedure proceeds to step S22. In step S22, the XHTML processor 16 determines that the media size is not device-setting, so that the procedure proceeds to step S23. In step S23, since the setting information that is not device setting, i.e., the setting information of media size, is a value indicating 2L size, the XHTML processor 16 checks whether this value (2L size) is registered for both the feeding trays.

As mentioned above, A4 size is set as the media size of the large feeding tray, and L size is set as the media size for the small feeding tray. Since the media size of 2L is not registered for either feeding tray, in this case, the procedure proceeds to step S24.

In step S24, the XHTML processor 16 checks whether the value of the print setting that is not device-setting, i.e., 2L as media size, is registered for either one of the feeding trays. In this case, the media size of 2L is not registered for either feeding tray, so that the procedure proceeds to step S25. Then, in step S25, the XHTML processor 16 replaces device setting of the media type in the print setting of the print data with “stationery sheet”, which is the media type registered for the large feeding tray.

Then, in step S27, the XHTML processor 16 checks the combination of media size and media type. Through the procedure up to step S26, 2L is set as the media size and stationery sheet is set as the media type in the print setting information of the print data. Thus, it is checked whether this setting information matches the first media definition information. With reference to the first media definition information defining combinations as shown in FIG. 9, it is understood that setting of stationery sheet as the media type is invalid when the media size is 2L size. Thus, the XHTML processor 16 determines that the combination is invalid, so that the procedure proceeds to step S28.

In step S28, the XHTML processor 16 checks whether the value of media size (2L) is registered for either one of the feeding trays. In this case, the value is not registered for either feeding tray, so that the procedure proceeds to step S30. Then, in step S30, the XHTML processor 16 checks whether the value of media type (stationery sheet) is registered for either one of the feeding trays. In this case, “stationery sheet” is registered as the media type for the large feeding tray, so that the procedure proceeds to step S31.

In step S31, the XHTML processor 16 changes the value of media size in the print setting information of the print data using the value registered for the large feeding tray. That is, the XHTML processor 16 replaces “2L” with “A4”, which is the value registered for the large feeding tray.

Then, in step S33, the XHTML processor 16 checks whether the combination of A4 size and stationery sheet, determined through the procedure described above, matches the information of either one of the feeding trays, registered in the multifunction machine 10. In this case, the combination of A4 size and stationery sheet coincides with the values registered for the large feeding tray. Thus, the procedure proceeds to step S35, in which the XHTML processor 16 checks whether the print quality in the print setting of the print data is device-setting. In this case, the value of print quality of the print data is “normal”, so that the procedure proceeds to step S37. In step S37, the XHTML processor 16 checks whether the combination of A4 size and stationery sheet is valid with reference to the first media definition information. According to the information shown in FIG. 9, the combination of A4 size and stationery sheet supports all print qualities. Thus, it is possible to execute printing properly with the print quality of “normal” set in advance for the print data.

Through the procedure described above, finally, the print setting of the print data is determined as “A4” as media size, “stationery sheet” as media type, and “normal” as print quality. That is, the large feeding tray, which corresponds to this print setting, is determined as a feeding tray that is to be used for printing the print data.

Next, specific description will be given in the context of a yet another case.

### Case 3

Now, a case will be considered where a CreateJob command with print setting information indicating “device-setting” as media size, “matte sheet” as media type, and “device-setting” as print quality is received.

First, in step S21, the XHTML processor 16 determines that device-setting is included in the media size, so that the procedure proceeds to step S22. In step S22, the XHTML processor 16 determines that the device type is not device-setting, so that the procedure proceeds to step S23.

In this case, the setting information that is not device-setting, i.e., the setting information of media type, is a value indicating matte sheet. Thus, in step S23, the XHTML processor 16 checks whether this value is registered for both the feeding trays.

As mentioned above, matte sheet is not registered for any feeding tray. Thus, the procedure proceeds to step S24. Furthermore, it is also determined in step S24 that matte sheet is not registered for any feeding tray. Thus, the procedure proceeds to step S25.

In step S25, the XHTML processor 16 replaces device-setting as media size in the print setting with “A4”, which is the media size registered for the large feeding tray.

Then, in step S27, the XHTML processor 16 checks the combination of media size and media type. Through the procedure up to step S26, A4 size is set as the media size and matte sheet is set as the media type in the print setting information. Thus, it is checked whether this setting information matches the first media definition information. With reference to the first media definition information shown in FIG. 9, when the media size is A4 size, the setting of matte sheet as the media type is allowed. Thus, the procedure proceeds to step S33.

In step S33, the XHTML processor 16 checks whether the combination of A4 size and matte sheet, determined through the procedure described above, coincides with the information of either one of the feeding trays, registered in the multifunction machine 10. In this case, the combination of A4 size and matte sheet does not coincide with the values registered for either one of the feeding trays. Thus, the procedure proceeds to step S34. In step S34, regardless of the print quality set in advance for the print data, the XHTML processor 16 sets an optimal print quality on the basis of the combination of media size and media size. That is, in this case, the second media definition information shown in FIG. 12 is used. First, the setting information of print quality set in advance for the print data is device-setting. Furthermore, the second media definition information defines that “normal” is suitable as the print quality for the combination of A4 size and matte sheet. Thus, the XHTML processor 16 replaces the setting information of print quality of the print data with “normal”.

Through the procedure described above, finally, the print setting of the print data is determined as “A4” as media size, “matte sheet” as media type, and “normal” as print quality. That is, the large feeding tray, which corresponds to this print setting, is determined as a feeding tray that is to be used for printing the print data.

The embodiment described above relates to XHTML printing from a digital television set. However, the present invention is not limited to XHTML printing. For example, the embodiment is applicable to cases where print setting can be delegated to a print processing apparatus and a printer has a plurality of feeding tray, as in the case of PictBridge.

The embodiment described above is directed to a case where a print processing apparatus has a plurality of feeding trays and stores information of sheets set in the individual feeding trays. In this case, optimal printing can be achieved even when a setting value for delegating print setting to the print processing apparatus is input. The setting value for delegating print setting to the print processing apparatus is, for example, “standard setting” in the case of PictBridge or “device-setting” in the case of XHTML printing.

Furthermore, according to the embodiment, when a setting value for delegating print setting regarding print quality to a print processing apparatus is received, optimal setting of print quality can be achieved even when a media size and a media type currently selected do not match information of sheets set in the feeding trays of the print processing apparatus.

As described above, with a print processing apparatus and a method of controlling a print processing apparatus according to the present invention, even when a “delegated setting value” for delegating print setting to a print processing apparatus is received by a printer regarding at least one of setting values of media size and media type in print setting information, an optimal print output can be obtained using information regarding media held in feeding trays.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-285827 filed Oct. 20, 2006 and No. 2007-161951 filed Jun. 19, 2007, which are hereby incorporated by reference herein in their entirety.

What is claimed is:

1. A print processing apparatus comprising:
a plurality of feeding units;
a memory unit configured to store media information regarding media individually held by the plurality of feeding units;
a holding unit configured to hold definition information in advance, the definition information defining combinations of media size and media type available in the print processing apparatus;
a receiving unit configured to receive print setting information from an external apparatus that requests printing, the print setting information including setting values of media size and media type; and
a processing unit configured to execute processing for determining a feeding unit to be used for printing among the plurality of feeding units on the basis of the print setting information, the media information, and the definition information,
wherein when at least one of the setting values of media size and media type in the print setting information is a delegated setting value for requesting that print setting be determined by the print processing apparatus, the processing unit replaces the delegated setting value with the media information of one of the plurality of feeding units, and determines with reference to the definition information whether it is allowed to execute printing according to the print setting information which replaces with the delegated setting value with the media information of one of the plurality of feeding units.

2. The print processing apparatus according to claim 1,
wherein when the processing unit has determined with reference to the definition information that it is not allowed to execute printing according to the print setting information which replaces the delegated setting value with the media information of one of the plurality of feeding units, the processing unit checks whether either the setting value of media size or the setting value of media type matches the media information of any one of the plurality of feeding units, and when either the setting value of media size or the setting value of media type matches the media information, the processing unit changes the print setting information which replaces the delegated setting value with the media information of one of the plurality of feeding units, using the media information of the feeding unit having matching media information.

3. The print processing apparatus according to claim 1,
wherein when the processing unit has determined with reference to the definition information that it is not allowed to execute printing according to the print setting information which replaces the delegated setting value with the media information of one of the plurality of feeding units, the processing unit checks whether either the setting value of media size or the setting value of media type matches the media information of any one of the plurality of feeding units, and when neither the setting value of media size nor the setting value of media type matches the media information, the processing unit changes the print setting information which replaces the delegated setting value with the media information of one of the plurality of feeding units, using the setting values of media size and media type of a feeding unit holding a media having a largest media size.

4. The print processing apparatus according to claim 1,
wherein the print setting information further includes a setting value of print quality,
wherein the definition information defines print qualities compatible with the combinations of media size and media type available in the print processing apparatus, and
wherein when the setting value of print quality in the print setting information is a delegated setting value for requesting that print setting be determined by the print processing apparatus, the processing unit replaces the delegated setting value on the basis of the definition information.

5. A method of controlling a print processing apparatus having a plurality of feeding units, the method comprising the steps of:
storing media information in a memory unit, the media information regarding media individually held by the plurality of feeding units;
reading definition information defining combinations of media size and media type available in the print processing apparatus;
receiving print setting information from an external apparatus that requests printing, the print setting information including setting values of media size and media type; and
executing processing for determining a feeding unit to be used for printing among the plurality of feeding units on the basis of the print setting information, the media information, and the definition information;
wherein, in the processing step, when at least one of the setting values of media size and media type in the print setting information is a delegated setting value for requesting that print setting be determined by the print processing apparatus, the delegated setting value is replaced with the media information of one of the plurality of feeding units, and it is determined with reference to the definition information whether it is allowed to execute printing according to the print setting information which replaces the delegated setting value with the media information of one of the plurality of feeding units.

6. The method according to claim 5,
wherein, in the processing step, when it has been determined with reference to the definition information that it is not allowed to execute printing according to the print setting information which replaces the delegated setting value with the media information of one of the plurality of feeding units, it is checked whether either the setting value of media size or the setting value of media type matches the media information of any one of the plurality of feeding units, and when either the setting value of media size or the setting value of media type matches the media information, the print setting information which replaces the delegated setting value with the media information of one of the plurality of feeding units is changed using the media information of the feeding unit having matching media information.

7. The method according to claim 5,
wherein, in the processing step, when it has been determined with reference to the definition information that it is not allowed to execute printing according to the print setting information which replaces the delegated setting value with the media information of one of the plurality of feeding units, it is checked whether either the setting value of media size or the setting value of media type matches the media information of any one of the plurality of feeding units, and when neither the setting value of media size nor the setting value of media type matches the media information, the print setting information which replaces the delegated setting value with the media information of one of the plurality of feeding units is changed using the setting values of media size and media type of a feeding unit holding a media having a largest media size.

8. The method according to claim 5,
wherein the print setting information further includes a setting value of print quality,
wherein the definition information defines print qualities compatible with the combinations of media size and media type available in the print processing apparatus, and
wherein, in the processing step, when the setting value of print quality in the print setting information is a delegated setting value for requesting that print setting be determined by the print processing apparatus, the delegated setting value is replaced on the basis of the definition information.
